(19) United States
(12) Patent Application Publication
(10) Pub. No.: US 2004/0064929 A1
(43) Pub. Date: Apr. 8, 2004

(54) Shelf formation system and method

(76) Inventors: Robert P. Yokabitus, Grand Rapids, MI (US); Christopher D. Bakale, Grand Haven, MI (US)

Correspondence Address: BRINKS HOFER GILSON & LIONE, P.O. BOX 10395, CHICAGO, IL, 60611, US

(21) Appl. No.: 10/267,038

(22) Filed: Oct. 8, 2002

(51) Int. Cl. B23P 17/00

(52) U.S. Cl. 29/417; 29/563; 29/564

(57) ABSTRACT

A method for forming a shelf is presented herein and includes shearing a straightened metal coil with a shearing mechanism and forming a sheared portion having a first length. The sheared portion has a first width and opposing ends that define a shelf width. The shearing mechanism is incorporated into a punch. The sheared portion is fed into a rollform mill set to receive sheared portions having the first width. The sheared portion is formed to have a predetermined depth. The sheared portion is fed into a press brake and at least one of the opposing ends of the sheared portion is bent with the press brake. The sheared portion is then ejected from the press brake.

### BACKGROUND

The present invention relates to shelf formation, and more specifically, to a shelf formation system and a method for forming shelves made from metal.

To form a shelf typically requires processing a coil of metal through several stations. These stations include a straightener to straighten the coil of metal, a punch to form holes in the shelf, and a rollform mill and press brake to form the shelf to the proper depth and to form the edges of the shelf, respectively. In addition, the coil of metal may be sheared so that the shelf is formed to the proper length.

There are several disadvantages associated with these types of shelf formation systems. One disadvantage is that a long changeover time is associated with the punch, rollform mill, and press brake. For example, if, after processing a coil of metal, it is desired to process a coil of metal having a different width, the settings associated with the rollform mill must be changed. This tooling changeover normally takes from one-half to one hour. Because of the long change over times associated with the equipment, it is not cost-effective to run small lots of shelves. Thus, conventional shelf formation systems often may not accommodate requests for smaller orders of shelves.

Because of the long change over time associated with the rollform mill, it is often advantageous to rollform a large quantity of metal before shearing it to proper length. This requires that a separate shearing machine, such as a stamping press, be provided to shear the metal after it is rollformed but before it is processed by the press brake. Thus, conventional shelf formation systems require an additional station solely dedication to shearing the metal. As with any system, the addition of equipment often results in addition maintenance being required and may increase the probability of system failures.

Accordingly, it would be advantageous to provide a shelf formation system that overcomes the disadvantage described above.

### BRIEF SUMMARY

A shelf formation system for forming metal shelves is presented herein. The system includes a punch adapted to form a repeating pattern of holes in a straightened, continuous length of coiled metal having a first width and to form a sheared portion having a predetermined length. The system also includes a rollform mill positioned downstream of the punch adapted to receive the sheared portion from the punch. The rollform mill is set to a first position and is adapted to form the sheared portion to a predetermined depth. A press brake positioned downstream of the rollform mill is adapted to receive the predetermined length of metal from the rollform mill. The press brake is adapted to form a bend in at least one of opposing ends of the sheared portion that defines a shelf width.

The current invention also embodies a method for forming a shelf. The method includes shearing a straightened metal coil with a shearing mechanism and forming a sheared portion having a first length. The sheared portion has a first width and opposing ends that define a shelf width. The shearing mechanism is incorporated into a punch. The sheared portion is fed into a rollform mill set to receive sheared portions having the first width. The sheared portion is formed to have a predetermined depth and is fed into a press brake. At least one of the opposing ends of the sheared portion is bent with the press brake and the sheared portion is then ejected from the press brake.

Another aspect of the invention embodies a method for changing over a punch, a rollform mill, and a press brake. The punch processes a straightened metal coil, and the rollform mill and press brake process a sheared portion formed by the punch. The sheared portion has a first width and a first length. The method includes changing over the punch in less than 30 seconds so that a first repeating pattern of holes applied to the straightened metal coil is changed to a second repeating pattern of holes applied to the straightened metal coil. The rollform mill is changed over in less than one minute so that the rollform mill processes a sheared portion having a second width. The press brake is changed over in 45 seconds to one minute inclusive so that the press brake processes a sheared portion having a second length.

The foregoing and other features and advantages will become further apparent from the following detailed description of the presently preferred embodiments, read in conjunction with the accompanying drawings.

### BRIEF DESCRIPTION OF SEVERAL VIEWS OF THE DRAWINGS

FIG. 1 is a perspective view of a shelf formed by the shelf formation system;

FIG. 2 is a plan view of the shelf formation system;

FIG. 3 is a top view of the coiled metal of FIG. 2; and

FIG. 4 is a top plan sectional view of the press brake.

### DETAILED DESCRIPTION OF THE PRESENTLY PREFERRED EMBODIMENTS

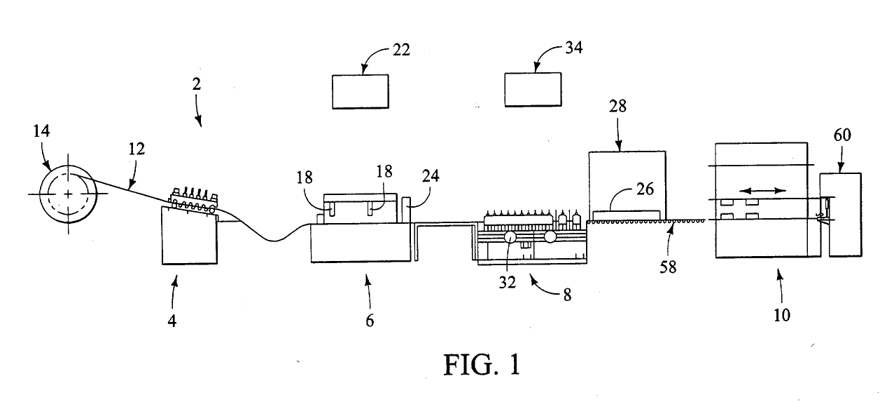

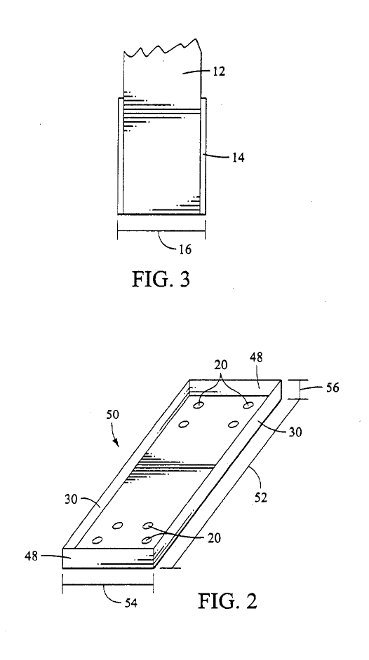

Referring now to FIGS. 1 and 2, a novel shelf formation system 2 and method are presented herein to form a shelf 50 having a predetermined length, width, and depth, the dimension of each depicted in FIG. 2 as 52, 54 and 56, respectively. Note that although the figures show the shelf as having a larger length than width, the present system and method may also be utilized with shelves having a larger width than depth. The shelf preferably is made of standard carbon steel, although any other suitable metal may be used. The shelf formation system 2 includes a coil straightener 4, a punch 6, a rollform mill 8, and a press brake 10. The coil straightener 4 receives a continuous length of metal 12 unwinding from a coil 14. The straightener 4 is a standard coil straightener familiar to those skilled in the art. The straightener processes, or straightens, the metal received from the coil.

The processed metal is then received by the punch 6. The punch is also a standard punch model, examples of which include PIVATIC, WIEDENANN, and FINN POWER. The punch is able to process coils of metal having a width 16 (see FIG. 3) preferably between and including 8 through 36 inches, although punches able to process other widths may also be used. The punch preferably includes two heads 18 that punch a repeating pattern of holes 20 into the metal 12. The holes preferably are for mounting the shelf 50.

The repeating pattern is determined according to a punch profile. The punch profile, which is preferably CNC programmable, is entered into a controller 22 electrically associated with the punch 6. The controller 22 then provides signals to direct the heads 18 to form the repeating pattern. If the hole pattern changes, a different punch profile may be entered into the controller. Moreover, in a preferred embodiment and as will be discussed further below, various punch profiles may be stored, as well as queued, within the controller.

The punch 6 also includes a shearing mechanism 24. After the pattern of holes 20 are formed in the metal 12, the shearing mechanism 24 shears a portion 26 of the metal to a predetermined length 28 (dimension labeled in FIG. 1). The sheared portion 26 includes the pattern of holes 20. The length 28 of the sheared portion is determined by specification requirements.

Note that a preferred embodiment contemplates a pattern of holes being formed into the metal. In alternate embodiments, however, the pattern of holes could be eliminated and the resulting shelf 50 could otherwise be mounted or utilized.

The sheared portion 26 is then received by the rollform mill 8. The rollform mill processes the sheared portion 26 via a standard roll forming operation to the predetermined shelf depth 56. This is accomplished by processing the opposing outer ends 30 of the sheared portion that define the shelf length 52. The depth also is determined by specification requirements. Preferably, however, the rollform mill 8 will process the sheared portion 26 such that it has a depth of 1.0 to 2.0 inches.

The rollform mill 8 also includes a motor 32 and a controller 34 electrically attached with the motor 32. As will be discussed further below, the motor 32 and controller 34 allow the rollform mill 8 to be “changed over” quickly in order to accommodate sheared portions of different widths.

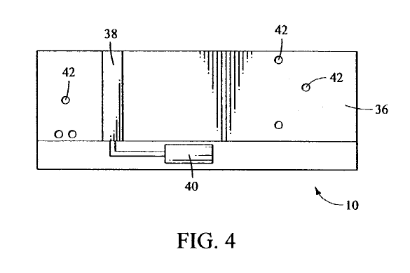

After being processed by the rollform mill 8, the sheared portion 26 is received by a press brake 10. Preferably, the press brake 10 simultaneously bends outer ends 48 that define the shelf width 54, although in alternate embodiments and depending on specifications, one outer end could also be bent. Referring to FIG. 4, the press brake 10 includes a die plate 36 and a die set 38. The die plate 36 and die set 38 allow the press brake to accommodate a variety of shelf lengths 52. Preferably, the shelf lengths are in the range of 20 to 60 inches inclusive, although, as those skilled in the art will readily understand, a press brake 10 may be used that accommodates other lengths as well, such as, for example, 22 to 71.5 inches exclusive.

The die plate 36 includes a plurality of receptacles 42, with each receptacle 42 positioned to accommodate a different shelf length 52. In a preferred embodiment, there are twenty receptacles, with each receptacle corresponding to a shelf length. In alternate embodiments, the number of receptacles may be varied. To process a shelf 50 of a given width 52, the die set engages with a receptacle 42 in the die plate 36 so that the press brake 10 may accommodate a shelf 50 of a corresponding length. To engage the die set with a different receptacle, a gear and track assembly 40 moves the die set 38 to a different receptacle 42.

In a preferred embodiment, the receptacles 42 are bushings. In other embodiments, however, other types of receptacles may be used that are able to engage with the die set.

To accommodate shelf lengths 52 not provided for by the bushings 42 of the die plate 36, a pair of attachments (not shown) such as cam locks may be used. The attachments lock the die set 38 to the die plate 36 and are positioned to correspond to a desired shelf length 52.

A method for forming a shelf 50 will now be described herein. Note that transport between the various stations may be accomplished through the use of standard equipment such as a belt drive 58. A continuous length of metal 12 unwinding from a coil 14 is fed into the coil straightener 4. The length of metal is then received by the punch 6. A pair of heads 18 associated with the punch 6 punch a repeating pattern of holes 20 into the length of metal. As noted above, the pattern is determined by the punch profile entered into the controller 22 associated with the punch 6. After the pattern has been punched into the metal, the metal is sheared into a sheared portion 26 by the shearing mechanism 24 to a predetermined length 28. The predetermined length includes the pattern.

The sheared portion 26 then proceeds to the rollform mill 8. The rollform mill 8 processes the sheared portion 26 by forming the ends 30 of the sheared portion that define the shelf length 52 to a predetermined depth 56. The sheared portion 26 is then received by the press brake 10. Preferably, the tooling associated with the press brake is of a convention wipe die-type. Moreover, in other embodiments, a rotary die may be used, or, as those skilled in the art will readily recognize, any other suitable type of forming die. The press brake 10 in one stroke bends the outer ends 48 of the sheared portion 26 that define the width 54 of the shelf 50 in one stroke. The now-formed shelf 50 is automatically ejected from the press brake.

Optionally, the shelf 50 may be transported to a painting station (not shown), or may be forwarded to a spot welding machine 60 to undergo a stiffener weld operation. Preferably, the spot welding machine is a PEERLESS spot welding machine that is tooled to simultaneously apply multiple welds to the shelf. In addition, other types of welders and welding processes, such as metal arc welding (MIG) or tungsten arc welding (TIG), could also be utilized.

Thus, a shelf formation system and method to form a shelf is set forth herein. There are numerous benefits associated with the system and method. One benefit is that a very short changeover time is associated with the punch, rollform mill, and press brake. This, in turn, allows for smaller lots to be processed. Because other systems have long changeover times associated with them, requests for smaller lots of shelves usually are not cost-effective and thus not advantageous. A brief description of the changeover associated with the punch, rollform mill, and press brake will now be set forth.

A changeover is performed on the rollform mill if, after processing coil of one width, a coil of a different width is to be processed. So that the rollform mill may receive metal coil (as sheared portions) of a different width, settings associated with the rollform mill must be changed. The changeover is accomplished by entering appropriate setting commands into the controller associated with the rollform mill. The commands are determined by the desired new width of the sheared portions. The controller sends a signal to the motor. The motor moves the settings of the rollform mill to a new position to accommodate sheared portions having the desired new width. Advantageously, this changeover takes less than approximately one minute, as compared with the changeover time associated with other rollform mill machines, which normally require about one-half to one hour.

To changeover the press brake, such as when a different shelf length is desired, the die set is moved from the receptacle within which it is currently residing into another receptacle that corresponds to the new desired shelf length. This is accomplished by manually manipulating a handle that causes the gear and track assembly to move the die set from one receptacle to another. As noted above, if there is no receptacle associated with a desired width, the attachments may be used to fasten the die set to the die plate in order to accommodate a new desired length. Either changeover operation takes approximately 45 seconds to one minute inclusive. Moreover, in addition to a changeover performed manually, the changeover could also be performed utilizing motors or mechanically, for example through the use of hydraulics or pneumatics.

No tooling changeover is required for the punch. Instead, a command is entered into the controller. The controller retrieves the appropriate punch profile and a new pattern is then applied accordingly. In addition, in some embodiments, various punch profiles may be preset, or queued, so that the punch applies a new pattern of holes at predetermined intervals without additional input to the controller being required. The changeover operation associated with the punch takes less than approximately 30 seconds.

Another benefit associated with the current system and method is that the shearing of the metal is performed at the punch and prior to rollforming. Other systems often will utilize a stamping press that shears the metal after it has been rollformed. Thus, in addition to the benefits described above, the present system is advantageous in that it requires less equipment and less complexity to perform the same processes.

Many modifications may be made to the current invention. For example, although two heads are contemplated for use with the punch, a different number of heads may be used. By way of further example, although a motor is used to change over the settings of the rollform mill, the rollform mill also may be changed over via hydraulics, pneumatics, or any other suitable method. Moreover, as with the punch, the commands associated with the changeover of the rollform mill may be queued within the controller so that the changeover of the rollform mill automatically occurs at preset intervals.

While the above description constitutes the preferred embodiments of the present invention, it will be appreciated that the invention is susceptible of modification, variation, and change without departing from the proper scope and fair meaning of the accompanying claims.

1. A shelf formation system comprising:
a punch adapted to form a repeating pattern of holes in a straightened, continuous length of coiled metal having a first width and to form a sheared portion having a predetermined length;
a rollform mill positioned downstream of the punch, wherein said rollform mill is adapted to receive the sheared portion from the punch, and wherein the rollform mill is set to a first position and is adapted to form the sheared portion to a predetermined depth; and
a press brake positioned downstream of the rollform mill, wherein said press brake is adapted to receive the predetermined length of metal from the rollform mill, wherein the press brake is adapted to form a bend in at least one of opposing ends of the sheared portion that defines a shelf width.

2. The shelf formation system of claim 1, wherein the rollform mill further comprises a motor and a controller, and wherein the controller provides a signal to the servo motor and the servo motor sets the rollform mill to a second position to form sheared metal having a second width to a predetermined depth.

3. The shelf formation system of claim 2, wherein the rollform mill is set to the second position in less than one minute.

4. The shelf formation system of claim 1, wherein the press brake further comprises a die plate having a plurality of receptacles positioned to accommodate sheared portions of varying lengths and a die set, and wherein the die set is moved to engage with a receptacle in the die plate in order to accommodate the sheared portions of varying lengths.

5. The shelf formation system of claim 4, wherein the plurality of receptacles is positioned to accommodate portions of metal sheared to 20 to 60 inches inclusive.

6. The shelf formation system of claim 4, wherein the press brake further comprises a gear and track assembly, and wherein the die set is moved from a first receptacle to a second receptacle by the gear and track assembly.

7. The shelf formation system of claim 4, wherein the press brake further comprises a pair of attachments, wherein the attachments fasten the die set to the die plate to accommodate sheared portions of varying lengths.

8. The shelf formation system of claim 7, wherein the lengths of the sheared portions are between 22 to 71.5 inches inclusive.

9. The shelf formation system of claim 1, wherein the punch will accommodate coils of metal having a width of 8 to 36 inches inclusive.

10. The shelf formation system of claim 1, wherein the rollform mill will form the sheared metal to have a depth of 1.0 to 2.0 inches inclusive.

11. The shelf formation system of claim 1, wherein the punch further comprises a controller and at least a pair of punching heads, wherein the punching heads form the repeating pattern of holes, and wherein the controller provides a signal to the punching heads to change the repeating pattern of holes to a different repeating pattern of holes.

12. The shelf formation system of claim 11, wherein the repeating pattern of holes is changed to the different repeating pattern of holes in less than thirty seconds.

13. A method for forming a shelf, comprising:
shearing a straightened metal coil with a shearing mechanism and forming a sheared portion having a first length, wherein the sheared portion has a first width and opposing ends that define a shelf width and wherein the shearing mechanism is incorporated into a punch;
feeding the sheared portion into a rollform mill set to receive sheared portions having the first width;
forming the sheared portion to have a predetermined depth;
feeding the sheared portion into a press brake;
bending at least one of the opposing ends of the sheared portion with the press brake; and
ejecting the sheared portion from the press brake.

14. The method of claim 13, further comprising:
punching a repeating pattern of holes into the straightened metal coil with the punch.

15. The method of claim 13, wherein the bending of at least one of the opposing ends of the sheared portion comprises simultaneously bending both opposing ends with the press brake.

16. The method of claim 13, further comprising:
forwarding the sheared portion to a spot welding machine after ejecting the sheared portion; and
performing a stiffening weld operation on the sheared portion by simultaneously applying multiple welds.

17. The method of claim 13, further comprising:
setting the rollform mill to receive sheared portions having a second width in less than one minute;
shearing a straightened metal coil having the second width to the first length and forming the sheared portion having the second width with the shearing mechanism, wherein the sheared portion having the second width includes opposing ends that define a shelf width;
feeding the sheared portion having the second width into the rollform mill;
forming the sheared portion having the second width to have a predetermined depth;
feeding the sheared portion having the second width into a press brake;
bending at least one of the opposing ends of the sheared portion with the press brake; and
ejecting the sheared portion from the press brake.

18. The method of claim 17, wherein setting the rollform mill to receive sheared portions having the second width in less than one minute further comprises:
entering a command into a controller;
providing a signal from the controller to a motor; and
setting the rollform mill from a first position to a second position via the motor.

19. The method of claim 13, further comprising:
setting the press brake to receive sheared portions having a second length in 45 seconds to one minute inclusive;
shearing the straightened metal coil and forming the sheared portion having the second length with the shearing mechanism, wherein the sheared portion has opposing ends that define a shelf width;
feeding the sheared portion having the second length into the rollform mill;
forming the sheared portion to have a predetermined depth;
feeding the sheared portion into a press brake;
bending at least one of the opposing ends of the sheared portion with the press brake; and
ejecting the sheared portion from the press brake.

20. The method of claim 19, wherein setting the press brake to receive sheared portions having the second length in 45 seconds to one minute inclusive further comprises:
moving a die set positioned within a first receptacle in a die plate to a second receptacle in the die plate.

21. The method of claim 20, wherein the die set is moved from a first receptacle to a second receptacle with a gear and track system.

22. The method of claim 19, further comprising:
punching a repeating pattern of holes into the straightened metal coil with the punch.

23. The method of claim 22, wherein punching the repeating pattern of holes into the portion of the straightened metal coil with the punch further comprises:
changing a first punch profile in less than thirty seconds so that a new repeating pattern of holes is punched into the straightened metal coil.

24. The method of claim 23, wherein changing the first punch profile in less than thirty seconds further comprises:
providing an input to a controller associated with the punch, wherein the controller replaces the first punch profile with a second punch profile; and
providing a signal from the controller to a pair of punching heads, wherein the punching heads apply the new repeating pattern of holes in accordance with the second punch profile.

25. A method for changing over a punch, a rollform mill, and a press brake, the punch processing a straightened metal coil, and the rollform mill and press brake processing a sheared portion formed by the punch, the sheared portion having a first width and a first length, the method comprising:
changing over the punch in less than 30 seconds, wherein a first repeating pattern of holes applied to the straightened metal coil is changed to a second repeating pattern of holes applied to the straightened metal coil;
changing over the rollform mill in less than one minute, wherein the rollform mill processes a sheared portion having a second width; and
changing over the press brake in 45 seconds to one minute inclusive, wherein the press brake processes a sheared portion having a second length.

26. The method of claim 25, wherein changing over the punch in less than 30 seconds further comprises:
providing an input to a controller associated with the punch such that the controller replaces a first punch profile with a second punch profile; and
providing a signal from the controller to a pair of punching heads such that the punching heads apply the second repeating pattern of holes in accordance with the second punch profile.

27. The method of claim 25, wherein changing over the rollform mill in less than one minute further comprises:
entering a command into a controller associated with the rollform mill;
providing a signal from the controller to a motor; and
setting the rollform mill from a first position to a second position via the motor such that the rollform mill accommodates the sheared portion having the second width.

28. The method of claim 25, wherein changing over the press brake in 45 seconds to one minute inclusive further comprises:
moving a die set positioned within a first receptacle in a die plate to a second receptacle in the die plate.
